(19) United States
(12) Patent Application Publication
(10) Pub. No.: US 2020/0092291 A1
(43) Pub. Date: Mar. 19, 2020

(54) Transfer/Sharing of Communication Sessions

(71) Applicant: Wells Fargo Bank, N.A., San Francisco, CA (US)

(72) Inventors: Madhu V. Vempati, Hyderabad (IN); Prasad N. Sivalanka, Hyderabad (IN)

(21) Appl. No.: 14/882,996

(22) Filed: Oct. 14, 2015

(51) Int. Cl. H04L 29/06; H04L 12/58; H04L 29/08; G06F 21/31

(52) U.S. Cl. CPC H04L 63/102; G06F 21/31; H04L 67/148; H04L 51/12

(57) ABSTRACT

A first electronic computing device receives a first message from a first user at a second electronic computing device to establish a communication. A determination is made as to whether a device identifier for the second electronic computing device is included in a profile of permissible electronic computing devices. When a determination is made that the device identifier is included in the profile, a communication session is established with the second electronic computing device. A second message is received from a second user at a third electronic computing device. A determination is made as to whether the second user is the same as a first user. When a device identifier for the third electronic computing device is included in the profile and the second user is the same as the first user, the communication session is transferred from the second electronic computing device to the third electronic computing device.

### BACKGROUND

Customers can login into accounts held by institutions using a plurality of electronic computing devices. Such devices can include desktop computers, laptop computers, tablet computers and smartphones. As an example, a customer can initiate an online banking session from a desktop computer at the customer's home or office.

When a communication session is established between a customer and an institution, the communication session is established between one electronic computing device of the customer and another electronic computing device, typically a server computer, at the financial institution. If the customer wants to continue a session on another electronic computing device (e.g., a mobile or tablet device), the customer typically needs to disconnect from the initial communication session and initiate a new communication session from the other electronic computing device.

### SUMMARY

Embodiments of the disclosure are directed to an electronic computing device comprising: a processing unit; and system memory, the system memory including instructions which, when executed by the processing unit, cause the electronic computing device to: receive a first message from a second electronic computing device to establish a communication session with the first electronic computing device; authenticate a first user from the request; obtain a device identifier for the second electronic computing device from the first message; determine whether the device identifier for the second electronic computing device is included in a profile of permissible electronic computing devices for the first user; when the first user is authenticated and when a determination is made that the device identifier is included in the profile of permissible electronic computing devices for the first user, establish the communication session with the second electronic computing device; receive a second message from a third electronic computing device to establish a communication session with the first electronic computing device; authenticate a second user from the second message; determine whether the second user is the same as the first user; obtain from the second message a device identifier for the third electronic computing device; determine whether the device identifier for the third electronic computing device is included in the profile of permissible electronic computing devices for the first user; and when a determination is made that the device identifier for the third electronic computing device is included in the profile of permissible electronic computing devices for the first user and when a determination is made that the second user is the same as the first user, transfer the communication session from the second electronic computing device to the third electronic computing device, so that the communication session is established between the third electronic computing device and the first electronic computing device.

In another aspect, a computer-readable data storage memory includes instructions that, when executed by a processing unit of an electronic computing device, cause the processing unit to: receive a first message from a second electronic computing device to establish a communication session with the first electronic computing device; authenticate a first user from the request; obtain a device identifier for the second electronic computing device from the first message; determine whether the device identifier for the second electronic computing device is included in the profile of permissible electronic computing devices associated with the first user; when the first user is authenticated and when a determination is made that the device identifier is included in the profile of permissible electronic computing devices associated with the first user, establish the communication session with the second electronic computing device; receive a second message from a third electronic computing device to establish a communication session with the first electronic computing device; determine whether the device identifier for the third electronic computing device is included in a profile of permissible electronic computing devices for the first user; when a determination is made that the device identifier for the third electronic computing device is included in the profile of permissible electronic computing devices for the user, send a third message to the third electronic device inquiring whether a user of the third electronic computing device wants to transfer the communication session or share the communication session; in response to the third message, receive a fourth message from the third electronic computing device; and when the fourth message indicates that the communication session is to be transferred, transfer the communication session between the second electronic computing device and the first electronic computing device from the second electronic computing device to the third electronic computing device, so that the communication session is between the third electronic computing device and the first electronic computing device.

In yet another aspect, an electronic computing device includes a processing unit; and system memory, the system memory including instructions which, when executed by the processing unit, cause the first electronic computing device to: create a profile for a first user on the first electronic computing device, the creation of the profile comprising: receive device identifiers for one or more electronic computing devices for the first user; and add each device identifier to a profile of permissible electronic computing devices to be associated with the first user; receive a first message from a second electronic computing device to establish a communication session with the first electronic computing device; authenticate a first user from the first message; obtain a device identifier for the second electronic computing device from the request; determine whether the device identifier for the second electronic computing device is included in the profile of permissible electronic computing devices associated with the first user; when the user is authenticated and when a determination is made that the device identifier is included in the profile of permissible electronic computing devices associated with the first user, establish the communication session with the second electronic computing device; receive a second message from a third electronic computing device to establish a communication session with the first electronic computing device; authenticate a second user from the second message; determine whether the second user is the same as the first user; when a determination is made that the second user is the same as the first user: obtain from the second message a device identifier for the third electronic computing device; determine whether the device identifier for the third electronic computing device is included in a profile of permissible electronic devices for the first user; and when a determination is made that the device identifier for the third electronic computing device is included in the profile of permissible electronic computing devices for the first user, transfer the communication session between the second electronic computing device and the first electronic computing device from the second electronic computing device to the third electronic computing device, so that the communication session is between the third electronic computing device and the first electronic computing device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a transfer or sharing of a communication session.

FIG. 2 shows an example connection between a user computing device of FIG. 1 and the server computing device of FIG. 1.

FIG. 3 an example user interface screen that can be displayed on a display screen of a user computing device of FIG. 1.

FIG. 4 shows an example table that can be used to store unique user computing device identifiers.

FIG. 5 shows a flowchart of an example method for seamlessly transferring or sharing a communication session.

FIG. 6 shows another flowchart of the example method for seamlessly transferring or sharing a communication session.

FIG. 7 shows yet another flowchart of the example method for seamlessly transferring or sharing a communication session.

FIG. 8 shows example physical components of the server computer of FIG. 1.

### DETAILED DESCRIPTION

The present disclosure is directed to systems and methods for seamlessly transferring a communication session from one electronic computing device to another electronic computing device. The systems and methods are also directed to sharing a communication session between multiple electronic computing devices.

Using the systems and methods, customers of an institution can have their electronic computing devices registered with the business. Registration comprises having a unique identifier for each of the electronic computing devices stored in a profile for the customer. Before a communication session is established, the institution verifies that the electronic computing device used by the customer is one that has been pre-registered for the customer with the institution. When the customer is authenticated and the electronic computing device used by the customer is validated, the customer is permitted to establish the communication session.

Using the systems and methods, once the communication session is established, the communication session can be seamlessly transferred to another electronic device or shared between multiple electronic computer devices. As discussed in more detail later herein, when a request to establish a communication session is received from a second electronic computing device of the customer, a device identifier for the second electronic computing device is sent to a server computer at the financial institution or business.

When the device identifier is determined to correspond to an electronic computing device that has been pre-registered for the customer, a user at the second electronic computing device is prompted to determine whether the user wants to transfer the communication session to the second electronic computing device or to share the existing communication session. Based on a response from the user, the communication session is either seamlessly transferred to the second electronic computing device or shared with the second electronic computing device. As used in this disclosure, a seamless transfer of a communication session comprises transferring the communication session without any loss of data and in a manner such that continuity is maintained in the communication session.

The systems and methods disclosed herein are directed to a computer technology that solves an existing problem involving transferring and sharing communication sessions. In today's environment it is common for an individual to have access to multiple electronic computing devices. The systems and methods make use of a unique device identifier for each of the multiple electronic computing devices to seamlessly permit a transfer of a communication session from one electronic computing device to another and to seamlessly share a communication session between multiple electronic computing devices. This permits the individual to start a communication session at one location (for example from the individual's office at a desktop computer) and then seamlessly transfer the communication session to another location (for example to a smartphone while the user walks to another location) while maintaining continuity of the communication session. In addition, by permitting multiple electronic computing devices registered to a user to share a communication session, multiple family members can simultaneously share a communication session (for example with a server computer at a financial institution) from different geographical locations.

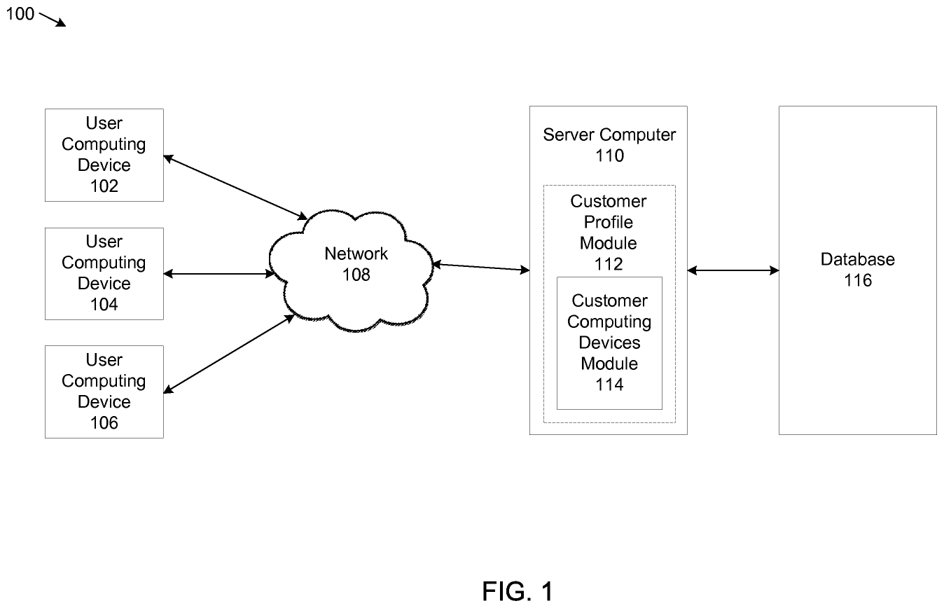

FIG. 1 shows an example system 100 that supports a seamless transfer and sharing of a communication session. The example system 100 includes user computing device 102, user computing device 104, user computing device 106, network 108, server computer 110 and database 116. Server computer 110 includes a customer profile module 112, which in turn includes a customer computing devices module 114.

The example user computing device 102, user computing device 104 and user computing device 106 are electronic computing devices that can be used by a customer of a financial institution or other business to logon to a web site of the financial institution or other business. The electronic computing devices can be one or more of desktop computers, laptop computers, tablet computers, smartphones or other similar type devices. For the example system 100, user computing device 102 is a desktop computer, user computing device 104 is a smartphone and user computing device 106 is tablet computer. More, fewer or different user computing devices can be used.

The example network 108 is computer network that can permit communication between one or more of user computing device, 102, 104, 106 and server computer 110. Network 108 can comprise a corporate Intranet and network 108 can also include the Internet.

The example server computer 110 is a server computer at the financial institution or other business organization. Server computer 110 can represent a single server computer, a cluster of server computers or a server computer farm. Server computer 110 stores or has access to customer records, customer profiles and other data records such as a registry of authorized customer computing devices. Server computer 110 can access records on database 116 or on other databases accessible from server computer 110.

For the sample system 100, server computer 110 includes a customer profile module 112 which in turn includes a customer computing devices module 114. The customer profile module 112 processes profile information for a customer. The profile information can include such items as customer preferences, customer interests, occupation, education, age, etc. The customer computing devices module 114 processes information regarding user computing devices that are registered for the customer. The processing can include receiving information about the user computing devices and associating a user computer device with the customer. The processing can also include receiving an access request from a user computing device and determining whether the user computing device is registered for the customer. Information that can be received regarding the user computing device can include a description of the user computer device, a type of the user computing device and a unique identifier for the user computing device, as discussed in more detail later herein. In some implementations the customer computing devices module 114 can be a module separate from the customer profile module 112.

The example database 116 is an electronic database that can store a plurality of customer records. Among the customer records, database 116 can store user customer profile records and records regarding user computing devices registered for the customer. The customer records can be accessed by server computer 110.

In an example implementation using system 100, user computing devices 102, 104 and 106 are registered to an authenticated customer of the financial institution or other business. In some implementations, the customer can login to server computer 110 using a software application on each on user computing devices 102, 104 and 106. The customer can select a feature on the software application for registering the user computing device. For example, the customer can select a feature for adding devices. As discussed in more detail later herein, the customer can manually enter some information such as a description of the user computing device and can select a type of the user computing device. For example the type can be selected from a menu of available device types such as desktop computer, laptop computer, iPad, Android tablet computer, iPhone and Android smartphone. More, fewer or different types can be available for selection. A unique device identifier can then be obtained from the user computing device and sent to server computer 110 to be registered.

After registering a user computer device, the customer can logon to server computer 110 from the user computer device to access an account for the customer. After the customer is authenticated (for example via a user ID and password), the unique identifier for the user computer device is sent to server computer 110. As discussed in more detail later herein, the unique identifier can be in one of several formats depending on the device type. When the unique identifier is received, the customer computing devices module 114 processes the unique identifier. The customer computing devices module 14 determines whether the unique identifier is in a table of registered devices for the customer. When a determination is made that the unique identifier has been registered for the customer, the customer is permitted to login to server computer 110 and access the customer account. However, when a determination is made that the user identifier is not in the table of registered devices for the customer, the customer is not permitted to login to server computer 110 and access the customer account.

When the customer is logged in to server computer 110, the customer may decide to transfer the login session to server computer 110 to another user computing device. For example, the customer may be logged in to server computer 110 from a desktop computer (for example from user computing device 102) at the customer's office and may decide to transfer the login session to a smartphone. While still logged in to server computer 110 from the desktop computer, the user can attempt to login to server computer 110 from the smartphone, using a software application on the smartphone.

When the user attempts to login from the smartphone, server computer can authenticate the user and then read the unique device identifier from the smartphone. Server computer 110 can then check current login sessions and for each current login session can determine whether the unique device identifier from the smartphone is listed in a table of registered devices for customers of any of the current login sessions. When a determination is made that the unique device identifier from the smartphone matches one of the registered devices for a customer of a current login sessions, server computer 110 can send a message to the smartphone inquiring whether the user of the smartphone would like to accept a transfer of the current login session or would like to login to the current session and share the current session with the desktop computer.

When the customer decides to accept a transfer of the current session, the login session is transferred from the desktop computer to the smartphone, so that the smartphone is connected to server computer 110. In some implementations, during the transfer, the session between the desktop computer and server computer 110 is ended and a new session is established between the smartphone and server computer 110. However, no data is lost from the previous session with the desktop computer and the transfer is seamless.

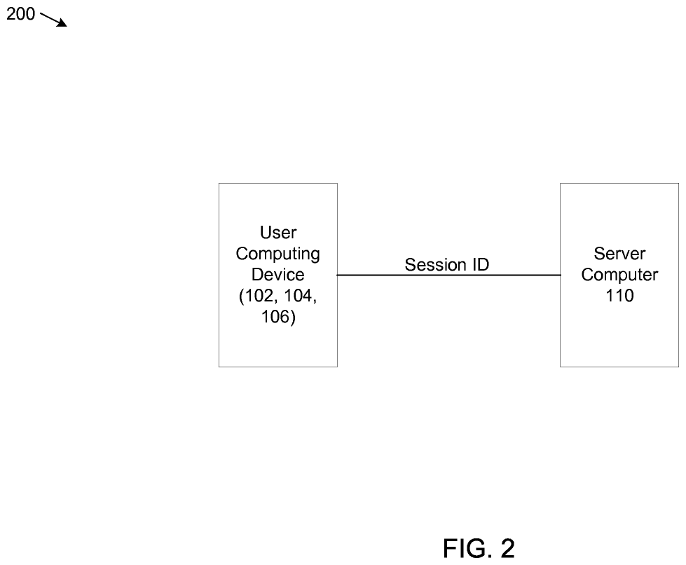

FIG. 2 shows an example diagram 200 showing a connection between a user computing device and server computer 110. When a first user computing device (for example user computing device 102) connects to server computer 110 and a communication session is established, a unique session ID is created for the communication session. When a second user computing device (for example user computing device 104) requests to join the communication session, the second user computing device can connect to the session using the same unique session ID.

Alternatively, as discussed earlier herein, the second user computing device can request that the communication session be transferred to the second user computing device. In some implementations, when server computer 110 receives a request from the second user computing device, the communication session between the first user computing device and server computer 110 is ended and a new communication session is created between the second communication device and server computer 110. However, the same session ID is used for each of the communication sessions, ensuring that continuity is maintained between the communication sessions and that no data is lost. In other implementations, different session IDs may be used for each communication session, but the session IDs can be linked so that continuity is maintained and that no data is lost.

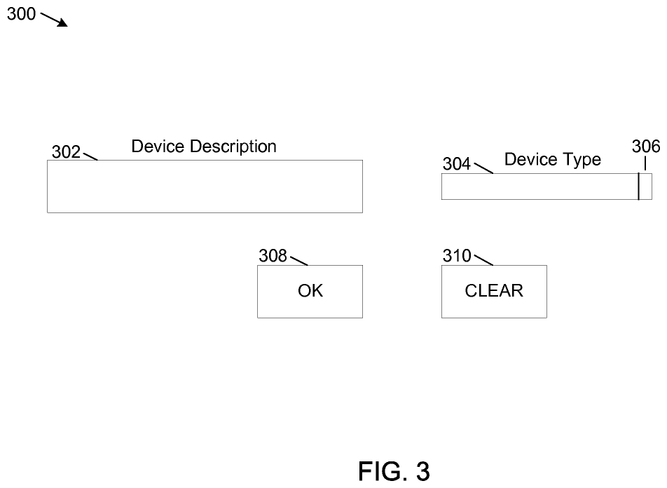

FIG. 3 shows an example user interface screen 300 that can be displayed on a display screen of a user computing device (user computing device 102, user computing device 104 or user computing device 106). The user interface screen 300 can be displayed when an individual at the user computing device activates a software application for registering the user computing device.

The example user interface screen 300 includes a text box 302 for entering a description of the user computing device, a pull-down list box 304 for selecting a device type for the user interface device, an OK button 308 and a Clear button 310. More, fewer or different graphical interface components can be used.

For an example implementation shown in FIG. 3, the pull-down list box 304 permits the user to select a device type of desktop computer, laptop computer, iPhone, Android smartphone, iPad and Android tablet computer. More, fewer or different device types can be provided. The user uses selector 306 to select a device type corresponding to the user computing device. The Clear button 310 can be used to clear text in the text box 302 and clear a selection in the pull-down list box 304.

For the example implementation, when the user selects the OK button 308, a unique identification number is obtained for the user computing device and the unique identification number along with the device description and device type are sent to server computer 110. For the example implementation, server computer 110 can store the device description, device type and unique identification number in a table on server computer 110, database 116 or on a server computer or database accessible from server computer 110.

The unique identification number is a number that uniquely identifies the user computing device. The unique identification number can have different formats depending on the device type. For smartphones, including the iPhone, the unique identification number can be an international mobile station equipment identity (IMEI) number. The IMEI number is a unique identifier for mobile phones and some satellite phones. The IMEI number can be obtained electronically from the smartphone. Desktop computers and laptop computers can have a unique identification number that can be obtained from the desktop or laptop computer. In some implementations this can be a 128-bit identification number. Unique identifiers for iPads can be yet another format. For example, an iPad can have a unique identifier that is a 40-digit sequence of numbers and letters. Other unique identifier formats for devices are possible.

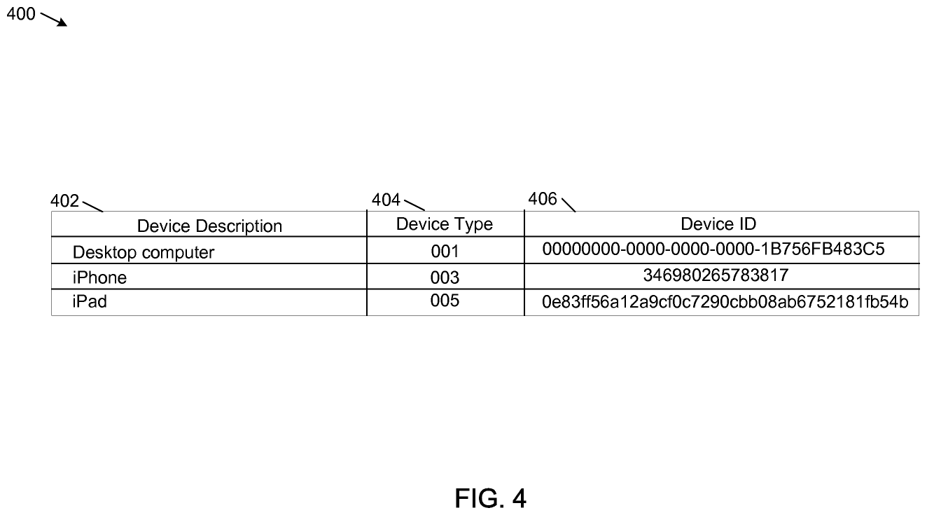

FIG. 4 shows an example table 400 that can be used to store unique user computing device identifiers. The table includes columns for device description 402, device type 404 and device ID. Three different device types are displayed in the example table 400. In an example implementation represented by table 400, a desktop computer has a device type of 001 and has a 128-bit (32 hexadecimal bytes) device identifier 406. An iPhone has a device type of 003 and an IMEI for a device identifier and an iPad has a device type of 005 and a 40-hexadecimal digit device identifier. Other device types and other device identifier formats are possible.

As stated earlier, the systems and methods can be used to transfer or share communication sessions between a user computing device and a financial institution or other business. One example of how the systems and methods can be used for other businesses can be an airline reservation system. For example, when multiple members of a family are travelling together, they typically want to set next to each other on an airplane. However, sometimes after a first seat assignment is made, by the time a second passenger checks in and requests a seat assignment, a seat near the first passenger may have been allocated to another customer. Using the systems and methods, when two or more family members have their own smartphone, each can check in and make their own seat assignment separately. If the family members check in at the same time using their individual smartphones and each of the smartphones is registered at the airline, when each of the family members check in, they can be connected to the airline registration system in a shared connection using a common session ID. In this way, they can each select an adjacent seat when the common communication session is active.

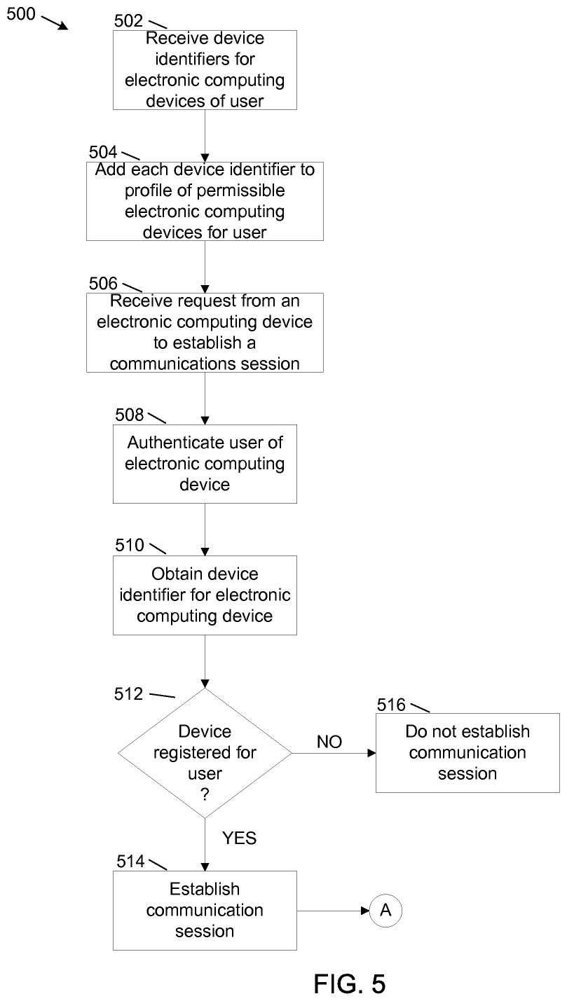

FIG. 5-7 show a flowchart of an example method 500 for seamlessly transferring/sharing a communication session. For method 500, the communication session is between one or more electronic computing devices (user computing devices 102, 104, 106) and a server computer (server computer 110). For method 500, server computer 110 is a server computer at a financial institution and user computing devices 102, 104, 106 are user computing devices of a customer of the financial institution. For method 500, user computing device 102 is a desktop computer, user computing device 104 is a smartphone and user computing device 106 is a tablet computer.

At operation 502, one or more device identifiers are received at server computer 110. The device identifiers are unique identifiers for one or more of user computing devices 102, 104 and 106. User computing devices 102,104, 106 send their unique identifiers to server computer 110 as part of a registration process for user computing devices 102, 104, 106. As part of the registration process, server computer 110 stores the unique identifiers in a table or similar data structure on server computer 110, database 116 or a server computer or database accessible from server computer 110.

At operation 504, server computer 110 adds each unique device identifier to a profile of permissible electronic computing devices for the customer. Adding the unique identifier to the profile comprises registering the user computing device for the user.

At operation 506, server computer 110 receives a request message from a user computing device (for example user computing device 102) to establish a communication session with server computer 110. For example, a customer at one of user computing device 102, user computing device 104 or user computing device 106 can access a software application on their user computing 102 and attempt to login to a customer account at the financial institution.

At operation 508, the user of the user computing device (in this example the customer of the financial institution) is authenticated by server computer 110. For method 500, the customer can enter a customer ID and password for the customer's account at the financial institution and server computer 110 can validate the customer ID and password. However, for method 500, authentication of the customer is not sufficient to permit access to the customer's account at the financial institution. Confirmation that the customer's user computing device is registered in also required.

At operation 510, server computer 110 obtains a device identifier for the customer's user computing device. The device identifier can be obtained from the user computing device and sent in a message to server computer 110. In one example implementation, the device identifier can be sent in the same request message as in operation 506. In other implementations, server computer 110 can request the device identifier after the user is authenticated and the user computer device can send the device identifier to server computer 110 in a separate request message.

At operation 512, a determination is made at server computer 110 as to whether the user computing device corresponding to the received device identifier is registered for the customer.

At operation 512, when a determination is made that the device identifier is registered for the customer (included in the profile of permissible electronic computing devices for the customer), at operation 514, a communication session is established between the user computing device and server computer 110 and the customer is permitted to login to the customer's accounts.

At operation 512, when a determination is made that the device identifier is not registered for the computer, at operation 516, a communication is not established between the user computing device and server computer 110 and the customer is not permitted access to the customer's accounts.

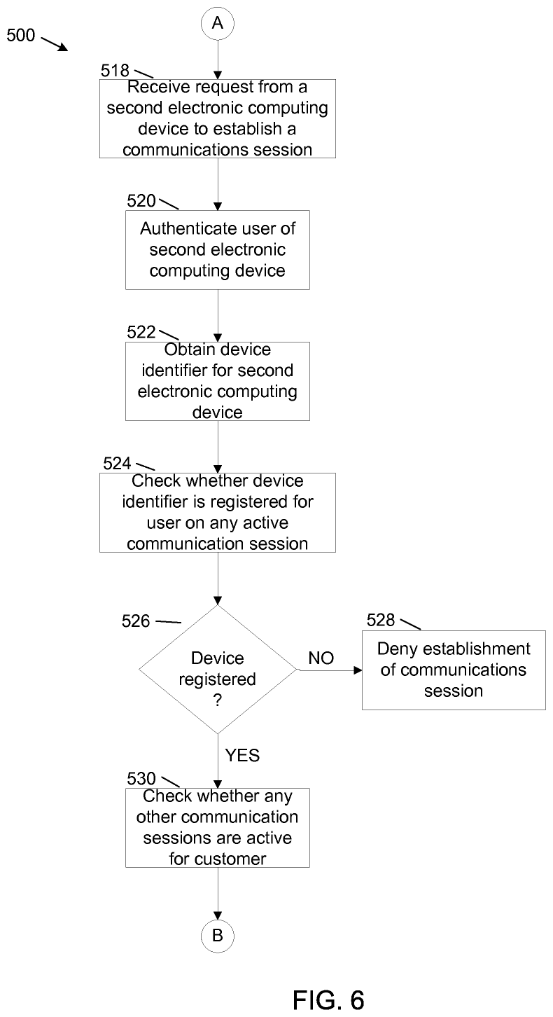

Now referring to FIG. 6, after a communication session is established between the user computing device and server computer 110, at operation 518, a request message is received at server computer 110 from a second user computing device (for example from user computing device 104) to establish a communication session between the second user computing device and server computer 110.

At operation 520, the user of the second user computing device is authenticated, typically via a customer ID and password.

At operation 522, a device identifier for the second user computing device is obtained. In an example implementation, as part of a login procedure, a software application on the second user computing device can obtain the device identifier from the second user computing device. The device identifier can be sent to server computer 110.

At operation 524, a check is made as to whether the second user computing device is registered for the customer. The second user computing device is considered to be registered for the customer when the device identifier for the second user computing device is included in the profile for permissible electronic computing devices for the customer.

At operation 526, when a determination is made that the second user computing device is not registered for the customer, at operation 528, a response message is sent to the second user computing device that the request to establish a communication session for the second user computing device is denied.

At operation 526, when a determination is made the second user computing device is registered for the customer, at operation 530, a check is made as to whether any other communication sessions are active for the customer.

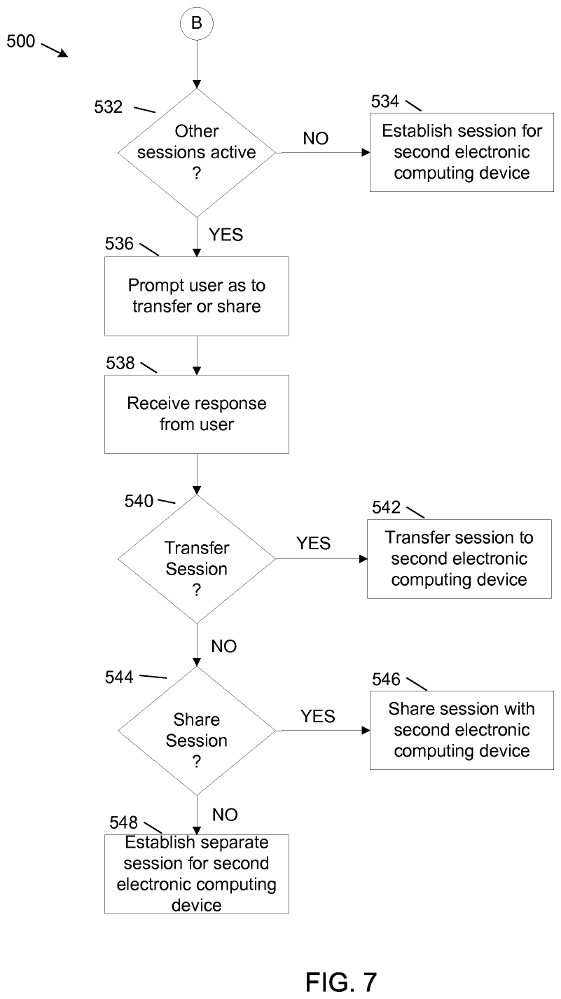

Now referring to FIG. 7, at operation 532, when a determination is made that no other communication sessions are active for the customer, at operation 534, a communication session is established between the second user computing device and server computer 110.

However at operation 532, when a determination is made that a communication session is active for the customer (as is the case for method 500), at operation 536, the customer is prompted as to whether the customer wants to transfer the active communication session to the second user computing device or whether the customer wants the second user computing device to share the active communication session. In an example implementation, the customer is prompted on the second user computing device when the second user computing device receives a prompting message from server computer 110.

At operation 538, server computer 110 receives a response to the prompt from the user. In an example implementation, the response indicates a user selection of transfer, share or new session.

At operation 540, when a determination is made that the customer wants to transfer the active communication session to the second user computing device, at operation 542, the active communication session is seamlessly transferred to the second user computing device. In an example implementation, seamlessly transferring the active communication session to the second user computing device comprises establishing a communication session between the second user computing device and server computer 110 using the same session ID as for the active communication session and then terminating the communication session between the first electronics computing device and server computer 110.

At operation 540, when a determination is made that the customer does not want to transfer the active communication session to the second user computing device, at operation 544, a check is made as to whether the customer at the second user computing device wants to share the active communication session.

At operation 544, when a determination is made that the customer at the second user computing device wants to share the active communication session, at operation 546, the second user computing device (user computing device 104) shares the activate communication session with the first user computing device (user computing device 102). In an example implementation, a communication session is established between the user electronics computing device and server computer 110 using the same session ID as for the communication session between the first user computing device and server computer 110. At the same time, the communication session between the first user computing device and server computer 110 is maintained.

At operation 544, when a determination is made that the customer at the second user computing device does not want to share the active communication session, at operation 548, a separate communication session is established between the second user computing device and server computer 110. The separate communication session uses a session ID that is different than the session ID used for the communication session between the first user computing device and server computer 110.

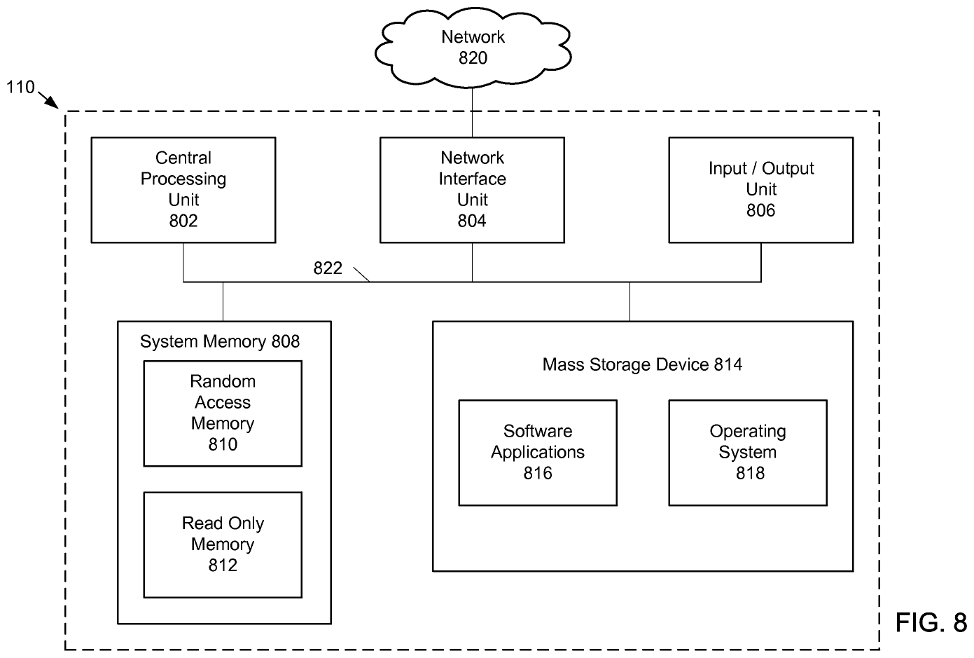

As illustrated in the example of FIG. 8, server computer 110 includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the server computer 110, such as during startup, is stored in the ROM 812. The server computer 110 further includes a mass storage device 814. The mass storage device 814 is able to store software instructions and data. Some or all of the components of the server computer 110 can also be included in user computing devices 102, 104 and 106.

The mass storage device 814 is connected to the CPU 802 through a mass storage controller (not shown) connected to the system bus 822. The mass storage device 814 and its associated computer-readable data storage media provide non-volatile, non-transitory storage for the server computer 110. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 110.

According to various embodiments of the invention, the server computer 110 may operate in a networked environment using logical connections to remote network devices through the network 820, such as a wireless network, the Internet, or another type of network. The server computer 110 may connect to the network 820 through a network interface unit 804 connected to the system bus 822. It should be appreciated that the network interface unit 804 may also be utilized to connect to other types of networks and remote computing systems. The server computer 110 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the server computer 110 can store software instructions and data. The software instructions include an operating system 818 suitable for controlling the operation of the server computer 110. The mass storage device 814 and/or the RAM 810 also store software instructions, that when executed by the CPU 802, cause the server computer 110 to provide the functionality of the server computer 110 discussed in this document. For example, the mass storage device 814 and/or the RAM 810 can store software instructions that, when executed by the CPU 802, cause the server computer 110 to display received data on the display screen of the server computer 110.

Although various embodiments are described herein, those of ordinary skill in the art will understand that many modifications may be made thereto within the scope of the present disclosure. Accordingly, it is not intended that the scope of the disclosure in any way be limited by the examples provided.

1. A first electronic computing device comprising:
a processing unit; and
system memory, the system memory including instructions which, when executed by the processing unit, cause the first electronic computing device to:
receive a first message from a second electronic computing device to establish a communication session with the first electronic computing device;
authenticate a first user associated with the first message;
obtain a first device identifier and a first device type for the second electronic computing device from the first message, wherein the first device identifier uniquely identifies the second electronic computing device, and wherein the first device type identifies a type of electronic device for the second electronic computing device;
determine whether the first device identifier and the first device type for the second electronic computing device are included in a profile of permissible electronic computing devices for the first user;
when the first user is authenticated and when a determination is made that the first device identifier and the first device type are included in the profile of permissible electronic computing devices for the first user, establish the communication session with the second electronic computing device;
receive a second message from a third electronic computing device to establish a communication session with the first electronic computing device;
authenticate a second user from the second message;
determine whether the second user is the same as the first user;
obtain from the second message a second device identifier and second device type for the third electronic computing device;
after receiving the second message from the third electronic computing device, determine whether the second device identifier and the second device type in the second message are included in the profile of permissible electronic computing devices for the first user; and
when a determination is made that the second device identifier and the second device type in the second message are included in the profile of permissible electronic computing devices for the first user and when a determination is made that the second user is the same as the first user:
send a third message from the first electronic computing device to the third electronic computing device inquiring whether the second user wants to transfer the communication session from the second electronic computing device to the third electronic computing device;
receive a fourth message from the third electronic computing device to the first electronic device; and
when the fourth message indicates that the second user wants to transfer the communication session from the second electronic computing device to the third electronic computing device, transfer the communication session from the second electronic computing device to the third electronic computing device, so that the communication session is established between the third electronic computing device and the first electronic computing device.

2. The first electronic computing device of claim 1, further comprising:
create a profile for the first user on the first electronic computing device, the creation of the profile for the first user comprising:
receive device identifiers for one or more electronic computing devices for the first user; and
add each device identifier to a profile of permissible electronic computing devices to be associated with the first user.

3. (canceled)

4. The first electronic computing device of claim 1, wherein transferring the communication session between the second computing device and the first electronic computing device from the second electronic computing device to the third electronic computing device comprises:
end the communication session between the second electronic computing device and the first electronic computing device; and
establish the communication session between the third electronic computing device and the first electronic computing device.

5. The first electronic computing device of claim 1, further comprising:
when the fourth message indicates that the second user wants to share the communication session with the second electronic computing device:
obtain a session identifier for the communication session between the second electronic computing device and the first electronic computing device; and
use the session identifier to connect the third electronic computing device to the first electronic computing device, so that a same communication session is established between the first electronic computing device, the second electronic computing device and the third electronic computing device.

6. The first electronic computing device of claim 5, wherein when the second device identifier and the second device type in the second message are not included in the profile of permissible electronic computing devices for the first user, a communication session with the third electronic computing device is not established.

7. The first electronic computing device of claim 1, further comprising:
when a determination is made that the second device identifier and the second device type in the second message are included in the profile of permissible electronic computing devices for the first user, and when a determination is made that the second user is not the same as the first user, connect the third electronic computing device to the first electronic computing device using the communication session established between the second electronic computing device and the first electronic computing device.

8. The first electronic computing device of claim 7, wherein connect the third electronic computing device to the first electronic computing device using the communication session established between the second electronic computing device and the first electronic computing device comprises:
obtain a session identifier for the communication session between the second electronic computing device and the first electronic computing device; and
use the session identifier to connect the third electronic computing device to the first electronic computing device, so that a same communication session is established between the first electronic computing device, the second electronic computing device and the third electronic computing device.

9. (canceled)

10. The first electronic computing device of claim 1, wherein when the first device identifier for the second electronic computing device is not included in the profile of permissible electronic computing devices for the first user, a communications session with the second electronic computing device is not established.

11. The first electronic computing device of claim 1, wherein the third electronic computing device is a smartphone and the second device identifier for the smartphone is an international mobile station equipment identity identifier for the smartphone.

12. The first electronic computing device of claim 1, wherein the second electronic computing device is a laptop computer or a desktop computer and the first device identifier for the laptop computer or the desktop computer is a unique identifier associated with the laptop computer or the desktop computer.

13. A computer-readable data storage memory comprising instructions that, when executed by a processing unit of a first electronic computing device, cause the processing unit to:
receive a first message from a second electronic computing device to establish a communication session with the first electronic computing device;
authenticate a first user associated with the first message;
obtain a first device identifier and a first device type for the second electronic computing device from the first message, wherein the first device identifier uniquely identifies the second electronic computing device, and wherein the first device type identifies a product brand for the second electronic computing device;
determine whether the first device identifier and the first device type for the second electronic computing device are included in the profile of permissible electronic computing devices associated with the first user;
when the first user is authenticated and when a determination is made that the first device identifier and the first device type are included in the profile of permissible electronic computing devices associated with the first user, establish the communication session with the second electronic computing device;
receive a second message from a third electronic computing device to establish a communication session with the first electronic computing device;
obtain from the second message a second device identifier and second device type for the third electronic computing device;
after receiving the second message from the third electronic computing device, determine whether the and the second device type are included in a profile of permissible electronic computing devices for the first user;
when a determination is made that the second device identifier and the second device type in the second message are included in the profile of permissible electronic computing devices for the user, send a third message to the third electronic computing device inquiring whether a user of the third electronic computing device wants to transfer the communication session or share the communication session;
in response to the third message, receive a fourth message from the third electronic computing device; and
when the fourth message indicates that the communication session is to be transferred, transfer the communication session between the second electronic computing device and the first electronic computing device from the second electronic computing device to the third electronic computing device, so that the communication session is between the third electronic computing device and the first electronic computing device.

14. The computer-readable data storage memory of claim 13, further comprising:
create a profile for a first user on the first electronic computing device, the creation of the profile comprising:
receive device identifiers for one or more electronic computing devices for the first user; and
add each device identifier to a profile of permissible electronic computing devices to be associated with the first user.

15. The computer-readable data storage memory of claim 13, wherein when the first device identifier for the second electronic computing device is not included in the profile of permissible electronic computing devices, a communication session with the second electronic computing device is not established.

16. The computer-readable data storage memory of claim 13, further comprising:
when the fourth message indicates that the communication session is to be shared, connect the third electronic computing device to the first electronic computing device using the communication session established between the second electronic computing device and the first electronic computing device.

17. The computer-readable data storage memory of claim 16, wherein connect the third electronic computing device to the first electronic computing device using the communication session established between the second electronic computing device and the first electronic computing device comprises:
obtain a session identifier for the communication session between the second electronic computing device and the first electronic computing device; and
use the session identifier to connect the third electronic computing device to the first electronic computing device, so that a same communication session is established between the first electronic computing device, the second electronic computing device and the third electronic computing device.

18. The computer-readable data storage memory of claim 13, wherein when the device identifier for the third electronic computing device is not included in the profile of permissible electronic computing devices, a communication session with the third electronic computing device is not established.

19. A first electronic computing device comprising:
a processing unit; and
system memory, the system memory including instructions which, when executed by the processing unit, cause the first electronic computing device to:
create a profile for a first user on the first electronic computing device, the creation of the profile comprising:
receive device identifiers for one or more electronic computing devices for the first user; and
add each device identifier to a profile of permissible electronic computing devices to be associated with the first user;
receive a first message from a second electronic computing device to establish a communication session with the first electronic computing device;
authenticate a first user associated with the first message;
obtain a first device identifier and a first device type for the second electronic computing device from the first message, wherein the first device identifier is an international mobile station equipment identity (IMEI) number that uniquely identifies the second electronic computing device, and wherein the first type identifies a product brand for the second electronic computing device;
determine whether the first device identifier and the first device type for the second electronic computing device are included in the profile of permissible electronic computing devices associated with the first user;
when the user is authenticated and when a determination is made that the first device identifier and the first device type are included in the profile of permissible electronic computing devices associated with the first user, establish the communication session with the second electronic computing device;
receive a second message from a third electronic computing device to establish a communication session with the first electronic computing device;
authenticate a second user from the second message;
determine whether the second user is the same as the first user;
when a determination is made that the second user is the same as the first user:
obtain from the second message a second device identifier and a second device type for the third electronic computing device;
after receiving the second message from the third electronic computing device, determine whether the second device identifier and the second device type in the second message are included in a profile of permissible electronic computing devices for the first user; and
when a determination is made that the second device identifier and the second device type in the second message are included in the profile of permissible electronic computing devices for the first user:
send a third message from the first electronic computing device to the third electronic computing device inquiring whether the second user wants to transfer the communication session from the second electronic computing device to the third electronic computing device; and
receive a fourth message from the third electronic computing device to the first electronic computing device;
when the fourth message indicates that the second user wants to transfer the communication session from the second electronic computing device to the third electronic computing device, transfer the communication session between the second electronic computing device and the first electronic computing device from the second electronic computing device to the third electronic computing device, so that the communication session is between the third electronic computing device and the first electronic computing device.

20. The first electronic computing device of claim 19, wherein the determination is made that the second user is not the same as the first user:
obtain from the second message from the third electronic computing device a second device identifier for the third electronic computing device;
determine whether the second device identifier for the third electronic computing device is included in a profile of permissible electronic devices for the first user; and
when a determination is made that the second device identifier for the third electronic computing device is included in the profile of permissible electronic computing devices for the first user:
obtain a session identifier for the communication session between the second electronic computing device and the first electronic computing device; and
use the session identifier to connect the third electronic computing device to the first electronic computing device, so that a same communication session is established between the first electronic computing device, the second electronic computing device and the third electronic computing device.
